(19) United States
(12) Patent Application Publication
(10) Pub. No.: US 2014/0160557 A1
(43) Pub. Date: Jun. 12, 2014

(54) SURGICAL MICROSCOPE

(71) Applicant: Leica Microsystems (Schweiz) AG, Heerbrugg (CH)

(72) Inventor: Ulrich SANDER, Rebstein (CH)

(21) Appl. No.: 14/098,776

(22) Filed: Dec. 6, 2013

(30) Foreign Application Priority Data
Dec. 7, 2012 (DE) 10 2012 222 578.1

(51) Int. Cl. G02B 21/18; G02B 21/00

(52) U.S. Cl. CPC G02B 21/18; G02B 21/0012
USPC 359/374

(57) ABSTRACT

The present invention relates to a surgical microscope comprising a first tube (8) and a second tube (9), wherein at least one sensor (21, 22, 23, 24, 25a, 25b) for sensing the position and/or orientation of the surgical microscope in three dimensions is provided, the first tube (8) and/or the second tube (9) being provided with a positioning and/or orientation device (110, 13, 18, 19, 13a, 18a, 19a) for positioning and/or orienting the first and/or the second tube (8, 9) as a function of a position and/or orientation, sensed by means of the at least one sensor (21, 22, 23, 24, 25a, 25b), of the surgical microscope in space.

### CROSS REFERENCE TO RELATED APPLICATIONS

This application claims priority of German patent application number 10 2012 222 578.1 filed Dec. 7, 2012, the entire disclosure of which is incorporated by reference herein.

### FIELD OF THE INVENTION

The present invention relates to a surgical microscope having a first microscope tube and a second microscope tube.

### BACKGROUND OF THE INVENTION

Surgical microscopes embodied as stereomicroscopes generally comprise a first stereoscopic tube for a principal surgeon and a second tube for a co-observer or assistant. This second tube is usually stereoscopic, but can also be embodied monoscopically. Surgical microscopes of this kind are known, and are usable in particular in ophthalmic and neurosurgical procedures.

During a procedure, a surgical microscope is often adjusted in three dimensions in terms of its position and/or orientation.

An adjustment of this kind is carried out as a rule by the principal surgeon, with the result that the position and orientation of the first and second tube are displaced in three dimensions. Conventionally, both the principal surgeon's tube and the assistant's tube can be repositioned or oriented manually, for example by releasing clamping mechanisms that are provided, or by overriding slip couplings. It is regarded as a particular disadvantage of conventional slip couplings that they are in most cases stiff, and must be very accurately and permanently adjusted for proper operation. Manual adjustment of the tubes in this manner also results in undesired movements and vibrations of the microscope, thereby extending, for example, the interruption periods between two desired positions of the surgical microscope, during which observation is not possible. This can result in delays in performing a procedure.

In particular, the need to adjust the co-observer's tube after a repositioning of the surgical microscope results in time delays during which the principal surgeon cannot work.

Surgical microscopes of this kind are known, for example, from DE 20 2004 021 053 U1 and DE 101 44 033 B4.

DE 102 43 852 A1 discloses a microscope in which sensing of a rotation angle of a tube with respect to the main body of the microscope is used in order to rotate an electronically generated image that is then introduced into a beam path.

### SUMMARY OF THE INVENTION

The intention of the present invention is therefore to minimize interruption periods as a result of movements or vibrations of the surgical microscope that are associated with a manual adjustment of observer tubes.

This is achieved with a surgical microscope having the features described herein.

With the surgical microscope according to the present invention, movements and vibrations of the microscope resulting from an adjustment of the position or orientation of observer tubes are effectively avoided. As a result, a surgical microscope is usable again after an adjustment, for example a change in the angle of view onto an object being observed, substantially more quickly than is the case with conventional approaches. Be it noted that the term “positioning and/or orientation device” that is used is intended to encompass both a translation furnished by the device (“positioning”) and/or a rotation (“orientation”). Devices in which exclusively a positioning or a suitable orientation of a tube can be effected are also conceivable.

Advantageous embodiments are disclosed herein. Further advantages and embodiments of the invention are evident from the description and from the attached drawings.

The positioning and/or orientation device usefully comprises a computation unit and at least one rotary joint having an actuating motor associated therewith. By suitable alignment of such rotary joints with respect to one another, it is possible in particular to make available in simple fashion a desired orientation of a tube in three dimensions.

It is particularly preferred to provide the first tube as a tube for a principal surgeon and the second tube as a tube for an assistant, the first tube being exclusively manually positionable and/or orientable, and the second tube comprising a positioning and/or orientation device as defined by the present invention. It is thereby possible, for example, to ensure that a principal surgeon can very quickly manually implement a desired orientation of the surgical microscope and of his or her own tube, but that the corresponding correction of the tube for the assistant can be effected without further delays in the usability of the microscope for the principal surgeon. An approach of this kind can also be made available in particularly inexpensive fashion, since a positioning and/or orientation device according to the present invention is provided only for the assistant.

According to a further preferred embodiment, it is possible for the positioning and/or orientation device of the first and/or second tube to be provided so that a position and/or orientation of the first or second tube existing before a movement of the surgical microscope is re-established. This function is advantageous in particular in the context of relatively small changes in the position of the surgical microscope. In the case of larger changes in the position or orientation of the surgical microscope, it proves to be advantageous simply to adapt the orientation, for example of the assistant's tube, to the greatest extent possible to an orientation that existed before the movement of the surgical microscope. It is particularly advantageous in this connection simply to re-establish that angle of inclination of a tube with reference to the horizontal which existed before a movement of the surgical microscope.

It is particularly preferred for the positioning and/or orientation device to have a function with which preselectable positions and orientations of the first and second tube can respectively be established. In particular, preselectable positions and orientations can in this context advantageously be established within specific predefinable limits.

In this connection, it proves to be particularly advantageous that the positioning and/or orientation device can propose a position and/or orientation of a tube, in particular for the case in which a position and/or orientation of the tube existing before a movement of the surgical microscope cannot be re-established. In an advantageous embodiment it is also possible to utilize body features of a user, if they are known, for example body size.

For safety reasons in particular, it proves to be useful that the first and/or the second tube are also provided manually adjustably. It is thereby possible to ensure, for example, safe operation of the surgical microscope even in the context of a defect in the electronic or electronically activated components of the orientation and/or positioning device.

According to a further preferred embodiment, an optical image orientation device, for example a Dove prism, is provided in the observation beam path of the assistant, in particular in the assistant's tube. This image orientation unit is orientable in accordance with the orientation of the assistant's tube, by means of a corresponding adjustment or orientation device (e.g. an actuating motor), in such a way that the assistant always obtains an upright and laterally correct image. Usefully, the positioning and/or orientation device of the assistant's tube and the adjustment or orientation device are coupled to one another in such a way that an adjustment of the tube automatically results in a corresponding adjustment of, for example, the Dove prism.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described in detail below with reference to the drawings.

### BRIEF DESCRIPTION OF THE DRAWING VIEWS

The Figures are described continuously and in overlapping fashion. Identical reference characters denote identical or similar components.

In the drawings:

FIG. 1 is a schematically simplified depiction of a preferred embodiment of a surgical microscope according to the present invention having a first tube for a principal surgeon and a second tube for an assistant.

### DETAILED DESCRIPTION OF THE INVENTION

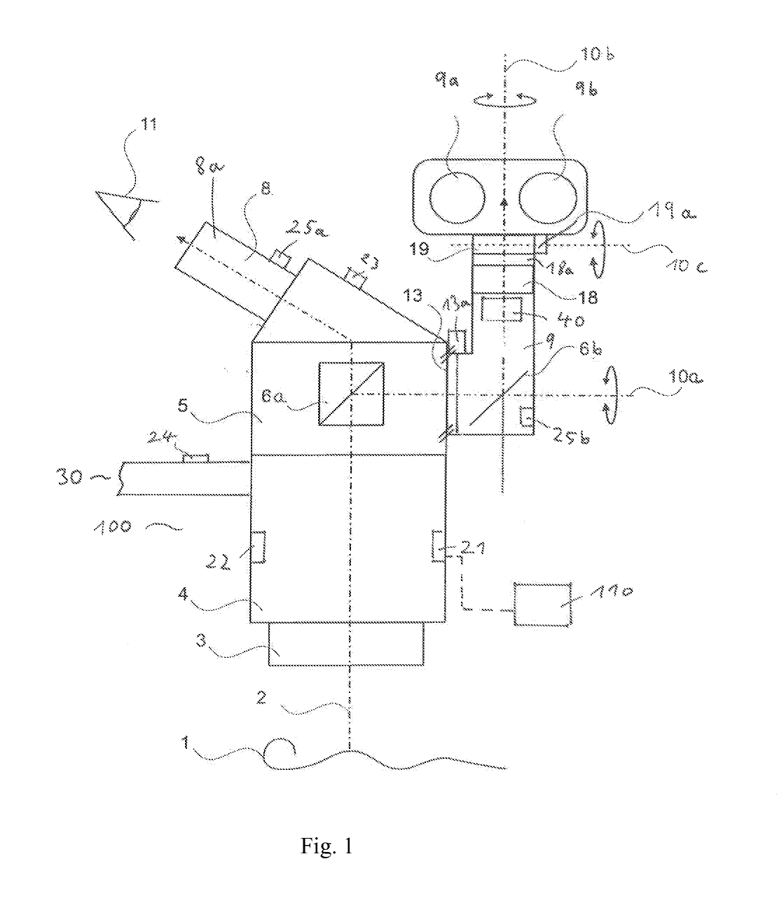

In FIG. 1, a preferred embodiment of a surgical microscope according to the present invention is depicted in a side view and is labeled 100 in its entirety. Surgical microscope 100 is embodied with a housing 5. In the side view depicted, only the right main stereo beam path 2 for the right eye 11 of a surgeon (principal surgeon) is depicted. Deflection elements and components for separating a beam path for the principal surgeon and for an assistant are labeled 6a, 6b.

The surgical microscope comprises a first tube 8 for the principal surgeon and a second tube 9 for the assistant. Both tubes 8, 9 are provided as binocular tubes; for perspective reasons, the depiction in FIG. 1 shows one eyepiece 8a for tube 8 and two eyepieces 9a, 9b for tube 9.

To ensure optimum observation of an object 1, surgical microscope 100 is pivotable through various angles in all three spatial dimensions in order to provide desired or suitable view angles onto object 1. In FIG. 1 this viewing angle, i.e. the angle between the surface of object 1 and the optical axis of the (schematically depicted) main objective 3 of the surgical microscope, is substantially 90 degrees.

In order to ensure this pivotability, surgical microscope 11 is suspended on a stand 30 that is depicted merely schematically. No further explanation is needed for the fact that stand 30 can be provided, for example, as a floor stand or ceiling stand.

When surgical microscope 100 is pivoted, it is necessary to ensure that first tube 8 for the principal surgeon and second tube 9 for the assistant can be looked into in an ergonomically acceptable manner. To ensure this, first tube 8 and second tube 9 are embodied with rotary joints. For the sake of clarity, these rotary joints are depicted in FIG. 1 exclusively for the second tube (assistant's tube) 9, and are labeled 13, 18, and 19.

Rotary joint 13 enables a rotation of second tube 9 about a first rotation axis 10a. Rotary joint 18 enables a rotation about second rotation axis 10b. Lastly, rotary joint 19 enables a rotation about a third rotation axis 10c.

All in all, rotary joints 13, 18, 19 that are depicted allow a desired orientation of tube 9 in three dimensions to be established. Not depicted, but likewise capable of being advantageously provided, are devices with which tube 8 and/or tube 9 can be displaced translationally. For example, tube 9 can be provided to be extendable along axis 10a and/or axis 10b. The devices for translational displacement, as well as rotary joints 13, 18, 19, represent positioning and/or orientation devices as defined by the present invention.

In order to sense its orientation in three dimensions, surgical microscope 100 is embodied with a number of sensors, which are depicted merely schematically and are labeled 21, 22, 23, 24, 25a, 25b. These sensors can be provided not only at positions 21, 22, 23 on surgical microscope housing 5 that are depicted by way of example, but at any other suitable positions, including in particular on stand 30 (sensor 24) or on first tube 8 or second tube 9 (sensors 25a, 25b). These sensors are, for example, orientation sensors for sensing a suitable number of degrees of freedom in terms of orientation and positioning. Particularly preferably, five or six degrees of freedom can be sensed by means of these sensors. Rotation sensors, gravitation sensors, acceleration sensors, and/or inertial sensors can in particular be used as such orientation sensors. The data acquired by these sensors are delivered to a (schematically depicted) control unit 110 associated with surgical microscope 100. For illustration, a connection between sensor 21 and control unit 110 is schematically depicted. Computation unit 110 is then capable of determining the present orientation or position of surgical microscope 100. Control unit 110 in turn activates actuating motors 13a, 18a, 19a associated with the respective rotary joints 13, 18, 19, which motors produce a suitable pivoting (or also displacement) of the second tube 9 corresponding to the present position of the surgical microscope.

To ensure that the assistant always obtains an upright and laterally correct image when using tube 9, an optical image orientation unit is schematically depicted in the assistant's tube (9) and is labeled 40. An image orientation unit of this kind can be provided in particular in the form of a Dove prism.

The repositioning of tube 9 produced in this context by the control device and the actuating motors can be carried out on the basis of a variety of criteria and basic settings. It is conceivable, for example, to re-establish a position or orientation of second tube 9 existing before a pivoting of surgical microscope 100. In this case the position in three dimensions of second tube 9, or at least of eyepieces 9a, 9b, remains constant.

It is likewise conceivable to implement a different suitable position or orientation of tube 9, by corresponding actuation of rotary joints 13, 18, 19 by means of actuating motors 13a, 18a, 19a respectively associated with them, on the basis of specific predefined criteria, for example a typical or known body size of the user who is using second tube 9. For this purpose, the control device can be set up to offer a number of appropriate positions to the user of second tube 9. For example, firstly a first position and/or orientation of second tube 9 could be suggested. If the user refuses this, a further position and/or orientation can be proposed. A refusal (or also an acceptance) of this kind can be effected, for example, by actuation of a suitable switch or also an acoustic command. Usefully, an appropriate three-dimensional angle region within which an orientation of the tube is to be possible can be stipulated by means of the control device.

Be it noted once again that in addition or alternatively to rotary joints 13, 18, 19 that are depicted, further rotary joints or also translational adjusting components are usable in order to ensure an optimum position or orientation of second tube 9 in three dimensions.

Be it noted further that it is possible to provide first tube 8 with automatic adjustability of this kind by means of actuating motors, acted upon by control device 110, that are associated with the rotary joints (not depicted) of first tube 8.

It is also to be noted, however, that in practice an embodiment of surgical microscope 100 in which first tube 8 for the principal surgeon is manually adjustable, and only second tube 9 for the assistant is provided to be automatically adjustable in the manner described, is advantageous. The reason for this is that in order to ensure a quick procedure, a principal surgeon generally prefers to bring surgical microscope 100 into a desired position or orientation by actuating corresponding handles on the microscope body. A corresponding manual adjustment of tube 8 proves to be fast and reliable in this context. Vibrations of the microscope occurring in the context of these movements can more easily be tolerated by the principal surgeon, especially since he or she is capable of producing quick manual damping of those vibrations (corresponding to the asymptotic limit case). Conventionally, however, after this pivoting, when the surgical microscope had in principle returned to a rest position, the assistant needed to reposition his or her (second) tube in accordance with the pivoting of the microscope selected by the principal surgeon, thereby producing further vibrations that delayed continuation of the procedure. These further vibrations can be avoided or at least minimized by means of the configuration of second tube 9, as illustrated, with automated adjusting means (control unit 110, rotary joints 13, 18, 19 having corresponding actuating motors 13a, 18a, 19a).

Usefully, second tube 9 is also manually adjustable. For this, rotary joints 13, 18, 19 can be provided with suitable slip couplings or releasable clamping mechanisms. Manual actuation of the second tube in this manner is provided, for example, for safety reasons.

According to a particularly advantageous embodiment of the invention, it is possible to combine automatic positioning and/or orientation by means of the positioning and/or orientation device according to the present invention with electronically controlled manual positioning and/or orientation. In this connection, for example, a manual realignment of a position of a tube selected by means of the positioning and/or orientation device is to be performed using a joystick device. With this feature as well, vibrations of the surgical microscope which can interfere with rapid usability even after repositioning can be minimized.

### PARTS LIST

2 Main stereo beam path
3 Main objective
5 Housing
6a, 6b Deflection elements
8 Tube
8a Eyepiece
9 Tube
9a, 9b Eyepieces
10a, 10b, 10c Rotation axes
11 Eye
13 Rotary joint
13a Actuating motor
18, 19 Rotary joints
18a, 19a Actuating motors
21, 22, 23, 24, 25a, 25b Sensors
30 Stand
40 Optical image orientation device
100 Surgical microscope
110 Control unit

What is claimed is:

1. A surgical microscope comprising:
a first tube (8);
a second tube (9);
at least one sensor (21, 22, 23, 24, 25a, 25b) for sensing a position and/or an orientation of the surgical microscope in three dimensions; and
a positioning and/or an orientation device (110, 13, 18, 19, 13a, 18a, 19a) associated with the first tube (8) and/or the second tube (9) for positioning and/or orienting the first tube (8) and/or the second tube (9) as a function of the position and/or the orientation of the surgical microscope in space sensed by the at least one sensor (21, 22, 23, 24, 25a, 25b).

2. The surgical microscope according to claim 1, wherein the positioning and/or orientation device comprises a computation unit (110) and at least one rotary joint (13, 18, 19) having an actuating motor (13a, 18a, 19a) associated therewith.

3. The surgical microscope according to claim 1, wherein the first tube (8) is provided as a tube for a principal surgeon and the second tube (9) is provided as a tube for an assistant, wherein the first tube (8) is exclusively manually positionable and/or orientable, and the positioning and/or an orientation device is associated with the second tube (9).

4. The surgical microscope according to claim 2, wherein the positioning and/or orientation device is operable to re-establish a previous position and/or orientation of the first tube (8) or the second tube (9) existing before a movement of the surgical microscope.

5. The surgical microscope according to claim 2, wherein the positioning and/or orientation device is operable to establish preselectable positions and orientations of the first tube (8) and the second tube (9), respectively.

6. The surgical microscope according to claim 4, wherein the positioning and/or orientation device can propose a position and/or orientation of one of the tubes (8, 9) when a position and/or orientation of the tube that existed before a movement of the surgical microscope cannot be re-established.

7. The surgical microscope according to claim 1, wherein the first tube (8) and/or the second tube (9) is manually adjustable.

8. The surgical microscope according to claim 3, further comprising an optical image orientation device (40) in an observation beam path of the second tube (9) for the assistant.
